(19) United States
(12) Patent Application Publication
(10) Pub. No.: US 2009/0214108 A1
(43) Pub. Date: Aug. 27, 2009

(54) SYSTEM AND METHOD FOR ISOLATING NEAR ACHROMATIC PIXELS OF A DIGITAL IMAGE

(76) Inventors: Jonathan Yen, San Jose, CA (US); William C. Kress, Vista, CA (US); Harold Boll, Winchester, MA (US); Robert Poe, Encinitas, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/037,711

(22) Filed: Feb. 26, 2008

(51) Int. Cl. G06K 9/00

(52) U.S. Cl. 382/163

(57) ABSTRACT

The subject application is directed to a system and method for isolating near achromatic pixels of a digital image. First, image data encoded as a plurality of pixels is received, with each pixel having component values in a multi-dimensional color space. From the received image data, chroma data is extracted. Histogram data is then calculated from the extracted chroma data. An adapted threshold value is then determined based upon the calculated histogram data. Component values of the plurality of pixels are then compared to the determined adapted threshold value. Isolation of pixels as near achromatic then occurs in accordance with the output of the comparison of the adapted threshold value to the component values.

### BACKGROUND OF THE INVENTION

The subject application is directed generally to analysis or classification of encoded images and is particularly suited for classification of portions of an encoded image as being near achromatic.

Electronic images are created or captured in many ways, such as from digital still cameras, digital motion cameras, digital imaging software, or the like. Typical images are captured as a plurality of pixels, each pixel being encoded as values in a multidimensional color space. An image may be captured in RAW format, or captured or converted to any suitable encoding scheme, such as RGB (red, green, blue) or CMYK (cyan, magenta, yellow, black). Image data is also suitably compressed, such as with a JPEG encoding scheme.

A typical image includes foreground and background portions, the foreground portion being, by way of example, the subject of a digital photograph. There are many algorithms that are suitably applied to adjust or correct an image by manipulation of its encoded image file.

Manipulation of encoded images is suitably accomplished via software operating on a general purpose computer, such as any suitable photo editing application. Such applications include functions for palette adjustment, altering hue, adjusting brightness, or performing white balancing. In addition, more sophisticated imaging or image acquisition systems may include a function by which such manipulation of image files is performed automatically.

One key aspect of image manipulation is that different portions of an image have distinct differences for application of adjustment or correction. Portions, such as a background portion, must be handled differently than other portions, such as a portion in the foreground. While a human operating a photo editing application may readily distinguish between portions of an image, an automated system for doing so is problematic.

### SUMMARY OF THE INVENTION

In accordance with one embodiment of the subject application, there is provided a system and method for analysis or classification of encoded images.

Further, in accordance with one embodiment of the subject application, there is provided a system and method for classification of portions of an encoded image as being near achromatic.

Still further, in accordance with one embodiment of the subject application, there is provided a system for isolating near achromatic pixels of a digital image. The system comprises means adapted for receiving image data encoded as a plurality of pixels, each pixel having component values in a multi-dimensional color space and means adapted for extracting chroma data from pixels of received image data. The system also comprises means adapted for extracting histogram data from extracted chroma data and means adapted for determining an adapted threshold value from extracted histogram data. The system further comprises comparison means adapted for comparing a determined adapted threshold value to component values of the plurality of pixels and isolation means adapted for isolating pixels as near achromatic in accordance with an output of the comparison means.

In one embodiment of the subject application, the system further comprises means adapted for assigning pixels to at least one of foreground and background of an image encoded in the image data in accordance with an output of the isolation means.

In another embodiment of the subject application, the system also comprises means adapted for applying a de-noising function to the image data in accordance with an output of the isolation means.

In yet another embodiment, the system also includes hue detection means adapted for detecting a hue of an image encoded in the image data in accordance with application of the de-noising function to the image data.

In a further embodiment of the subject application, the system also includes means adapted for receiving input image data and means adapted for converting received input image data into the image data encoded in HSV color space.

In still another embodiment of the subject application, the system further includes means adapted for down-sizing image data prior to extraction of chroma data therefrom.

Still further, in accordance with one embodiment of the subject application, there is provided a method for isolating near achromatic pixels of a digital image in accordance with the system as set forth above.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject application is described with reference to certain figures, including:

FIG. 1 is an overall diagram of a system for isolating near achromatic pixels of a digital image according to one embodiment of the subject application;

FIG. 2 is a block diagram illustrating controller hardware for use in the system for isolating near achromatic pixels of a digital image according to one embodiment of the subject application;

FIG. 3 is a functional diagram illustrating the controller for use in the system for isolating near achromatic pixels of a digital image according to one embodiment of the subject application;

FIG. 4A is an example image for use with the system and method for isolating near achromatic pixels of a digital image according to one embodiment of the subject application;

FIG. 4B is an example image illustrating near achromatic pixels of the image of FIG. 4A in accordance with one embodiment of the system and method for isolating near achromatic pixels of a digital image according to the subject application;

FIG. 5A is another example image for use with the system and method for isolating near achromatic pixels of a digital image according to one embodiment of the subject application;

FIG. 5B is an illustration of the background pixels of the image of FIG. 5A for use with the system and method for isolating near achromatic pixels of a digital image according to one embodiment of the subject application;

FIG. 5C illustrates an example image for use with the system and method for isolating near achromatic pixels of a digital image according to one embodiment of the subject application;

FIG. 5D is an illustration of the foreground pixels of the image of FIG. 5C for use with the system and method for isolating near achromatic pixels of a digital image according to one embodiment of the subject application;

FIG. 6A is another example image for use with the system and method for isolating near achromatic pixels of a digital image according to one embodiment of the subject application;

FIG. 6B is a hue histogram in HSV corresponding to the image of FIG. 6A for use with the system and method for isolating near achromatic pixels of a digital image according to one embodiment of the subject application;

FIG. 6C is a de-noised hue histogram corresponding to the input image of FIG. 6A for use with the system and method for isolating near achromatic pixels of a digital image according to one embodiment of the subject application;

FIG. 6D is an illustration of the input image of FIG. 6A, depicting the discarded pixels in accordance with the de-noising histogram of FIG. 6C for use with the system and method for isolating near achromatic pixels of a digital image according to one embodiment of the subject application;

FIG. 7 is an example illustration of input images depicting pixels having low hue and saturation values for use with the system and method for isolating near achromatic pixels of a digital image according to one embodiment of the subject application;

FIG. 8 is an illustration of several sets of images depicting various threshold values for use with the system and method for isolating near achromatic pixels of a digital image according to one embodiment of the subject application;

FIG. 9 is a depiction of a normalized chroma histogram for use with the system and method for isolating near achromatic pixels of a digital image according to one embodiment of the subject application;

FIG. 10 is an example implementation of the system and method for isolating near achromatic pixels of a digital image according to one embodiment of the subject application;

FIG. 11 is a flowchart illustrating a method for isolating near achromatic pixels of a digital image according to one embodiment of the subject application; and

FIG. 12 is a flowchart illustrating a method for isolating near achromatic pixels of a digital image according to one embodiment of the subject application.

### DETAILED DESCRIPTION OF THE PREFERRED EMBODIMENT

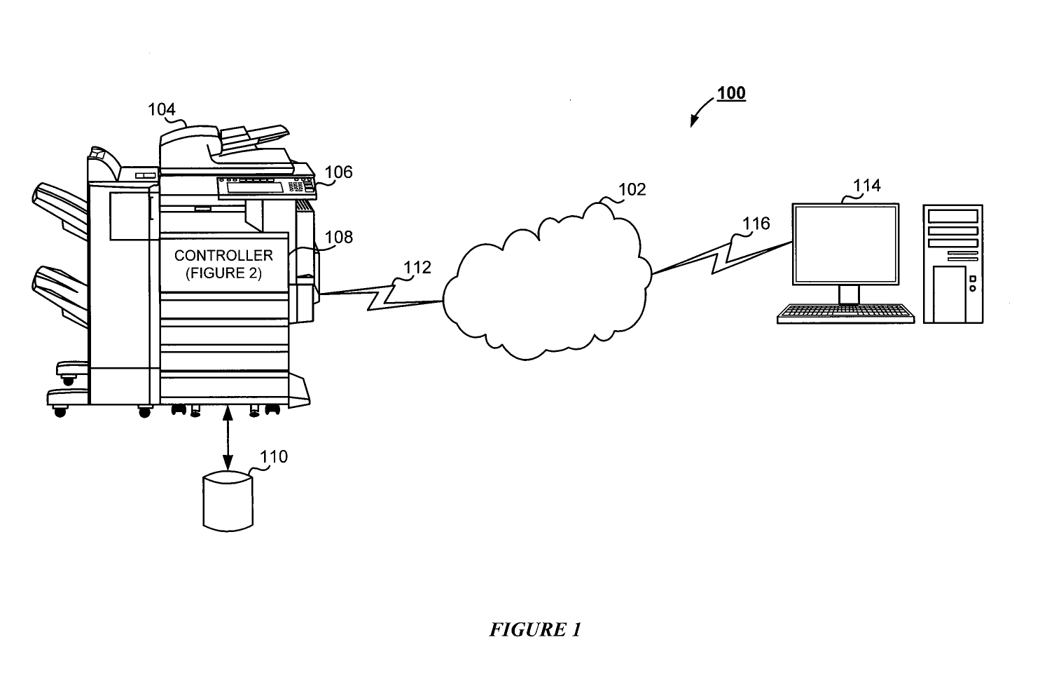

The subject application is directed to a system and method for analysis or classification of encoded images. In particular, the subject application is directed to a system and method for classification of portions of an encoded image as being near achromatic. More particularly, the subject application is directed to a system and method for isolating near achromatic pixels of a digital image. It will become apparent to those skilled in the art that the system and method described herein are suitably adapted to a plurality of varying electronic fields employing image processing including, for example and without limitation, communications, general computing, data processing, document processing, and the like. The preferred embodiment, as depicted in FIG. 1, illustrates a document processing field for example purposes only and is not a limitation of the subject application solely to such a field.

Referring now to FIG. 1, there is shown an overall diagram of a system 100 for isolating near achromatic pixels of a digital image in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, and the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof configured to interact with an associated user, a networked device, or the like.

According to one embodiment of the subject application, the document processing device 104 is suitably equipped to receive a plurality of portable storage media including, without limitation, Firewire drive, USB drive, SD, MMC, XD, Compact Flash, Memory Stick, and the like. In the preferred embodiment of the subject application, the document processing device 104 further includes an associated user interface 106 such as a touch-screen, LCD display, touch-panel, alpha-numeric keypad, or the like via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user; receive input from the associated user; and communicate the same to a backend component such as a controller 108, as is explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

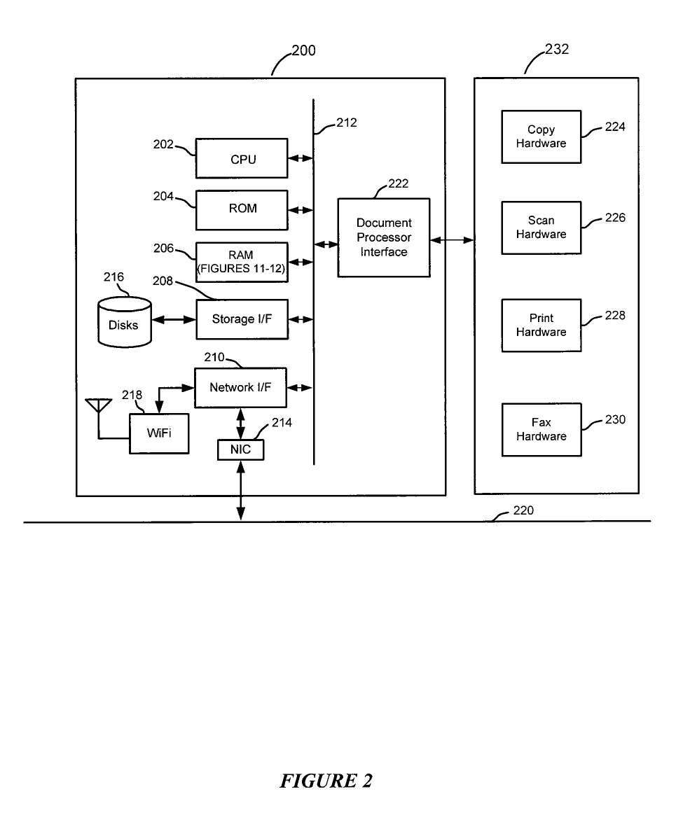

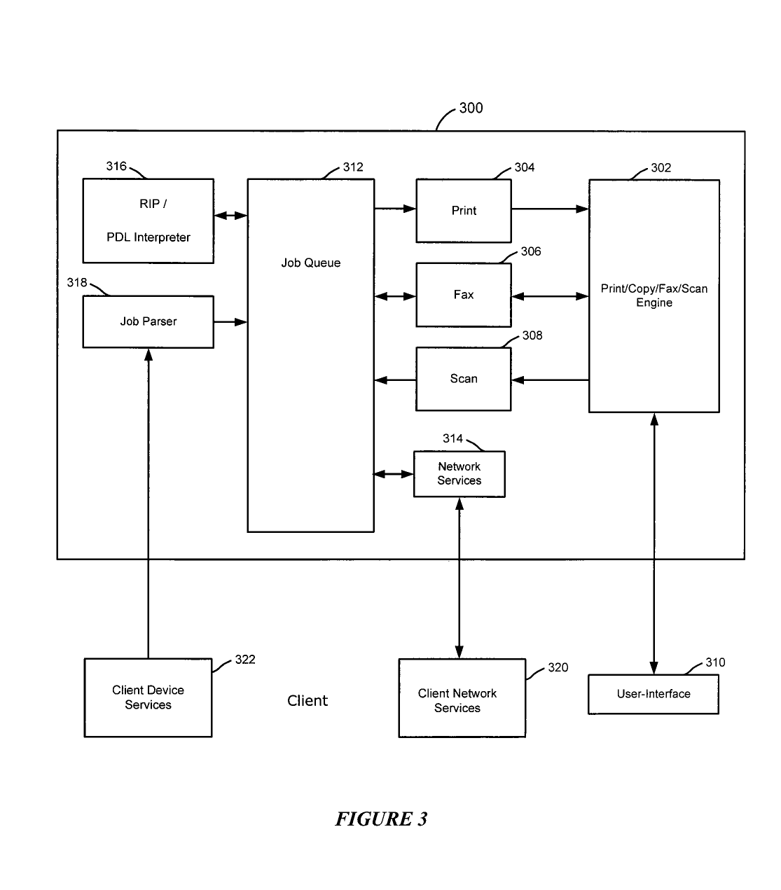

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, facilitate the display of images via the user interface 106, direct the manipulation of electronic image data, and the like. For purposes of explanation, the controller 108 is used to refer to any of the myriad components associated with the document processing device 104 including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art and, thus, the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for isolating near achromatic pixels of a digital image of the subject application. The functioning of the controller 108 will be better understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, and the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, an internal hard disk drive or the like.

The system 100 illustrated in FIG. 1 further depicts a user device 114 in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the user device 114 is suitably adapted to generate and transmit electronic documents, document processing instructions, user interface modifications, upgrades, updates, personalization data, or the like to the document processing device 104 or any other similar device coupled to the computer network 102.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device known in the art that is capable of facilitating the methodologies described herein. Included is a processor 202 suitably comprised of a central processor unit. However, it will be appreciated that the processor 202 may advantageously be composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the controller 200.

Also included in the controller 200 is random access memory 206 suitably formed of dynamic random access memory; static random access memory; or any other suitable, addressable, and writable memory system. Random access memory 206 provides a storage area for data instructions associated with applications and data handling accomplished by the processor 202.

A storage interface 208 suitably provides a mechanism for non-volatile, bulk, or long term storage of data associated with the controller 200. The storage interface 208 suitably uses bulk storage, such as any suitable addressable or serial storage such as a disk, optical, tape drive and the like, as shown as 216, as well as any suitable storage medium, as will be appreciated by one of ordinary skill in the art.

A network interface subsystem 210 suitably routes input and output from an associated network, allowing the controller 200 to communicate to other devices. The network interface subsystem 210 suitably interfaces with one or more connections with external devices to the controller 200. By way of example, illustrated is at least one network interface card 214 for data communication with fixed or wired networks such as Ethernet, token ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device such as the document processing device 104, which includes the controller 200 of FIG. 2 (shown in FIG. 1 as the controller 108) as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality, as will be appreciated by one of ordinary skill in the art.

In the preferred embodiment, the engine 302 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 302 is suitably interfaced to a user interface panel 310, which panel 310 allows for a user or administrator to access functionality controlled by the engine 302. Access is suitably enabled via an interface local to the controller or remotely via a remote thin or thick client.

The engine 302 is in data communication with print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms such as bit map, page description language or vector format, and the like are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network-based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter, or any suitable mechanism for interchange of an electronic document to a format better suited for interchange with device functions such as print 304, facsimile 306, or scan 308.

Finally, the job queue 312 is in data communication with a job parser 318, which job parser 318 suitably functions to receive print job language files from an external device such as client device services 322. The client device services 322 suitably include printing, facsimile transmission, or other suitable input of an electronic document for which handling by the controller function 300 is advantageous. The job parser 318 functions to interpret a received electronic document file and relay it to the job queue 312 for handling in connection with the afore-described functionality and components.

In operation, image data encoded as a plurality of pixels is received, each pixel having component values in a multi-dimensional color space. Chroma data is then extracted from pixels of the received image data. Histogram data is then extracted from the extracted chroma data. Next, an adapted threshold value is determined from the extracted histogram data. The determined adapted threshold value is then compared to component values of the plurality of pixels. Pixels are then isolated as near achromatic in accordance with the output of the comparison of the determined adapted threshold value to the component values.

In accordance with one example embodiment of the subject application, input image data is received, for example from the user device 114, via operations of the document processing device 104 or the like. It will be understood by those skilled in the art that, while reference is made hereinafter to the controller 108 associated with the document processing device 104 performing the methodology discussed below, the subject application is capable of implementation via any suitable computing device known in the art. Thus, the skilled artisan will appreciate that the references to the controller 108 are for example purposes only, and the user device 114, another suitable component associated with the document processing device 104, a self-service kiosk, or other such device capable of performing such operations discussed below is also capable of being used in accordance with the subject application. As will be appreciated by those skilled in the art, the received image data is capable of corresponding to data representing an electronic image in any of myriad various formats, e.g., JPEG, TIFF, PDF, RAW, BMP, etc. It will further be understood by those skilled in the art that the image data is encoded as a plurality of pixels, each having component values in a multi-dimensional color space, e.g., RGB, CMYK, HSV, CIE L*a*b*, YC_{b}Cᵣ, YIQ, xyY, u′v′Y, L*u*v*, or the like, as will be known in the art.

The controller 108 or other suitable component associated with the document processing device 104, the user device 114, or the like then determines whether the received image data requires conversion to a suitable color space for further processing in accordance with the subject application, e.g., conversion to luminance-chrominance color space encoded image data, conversion to HSV (Hue, Saturation, Value (brightness)) encoded image data, or the like. When conversion is required, the received input image is converted to suitable color space encoded image data, as will be appreciated by those skilled in the art. The received image data in an acceptable format, i.e., as received or following conversion, is then analyzed to determine whether the size of the received image exceeds a predetermined size. That is, the determination is made whether the large size of the image will result in a strain on computational resources associated with the controller 108, other suitable component of the document processing device 104, the processing of the user device 114, or the like. When the received image is large enough to adversely affect performance of the associated device, e.g., the controller 108, the document processing device 104, the user device 114, etc., the image is down-sized via any suitable means known in the art. In accordance with one embodiment of the subject application, the term “down-sizing” corresponds, for example and without limitation, to the reduction in the number of pixels in a given image, as will be understood by those skilled in the art. Preferably, the received image is blurred and/or down-sampled, so as to result in an input image having a suitably smaller size for further processing in accordance with the subject application.

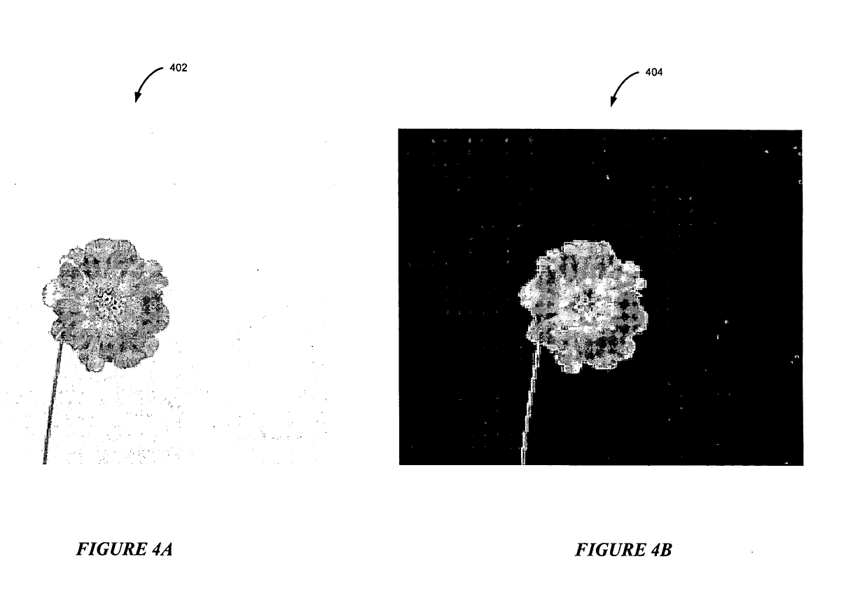

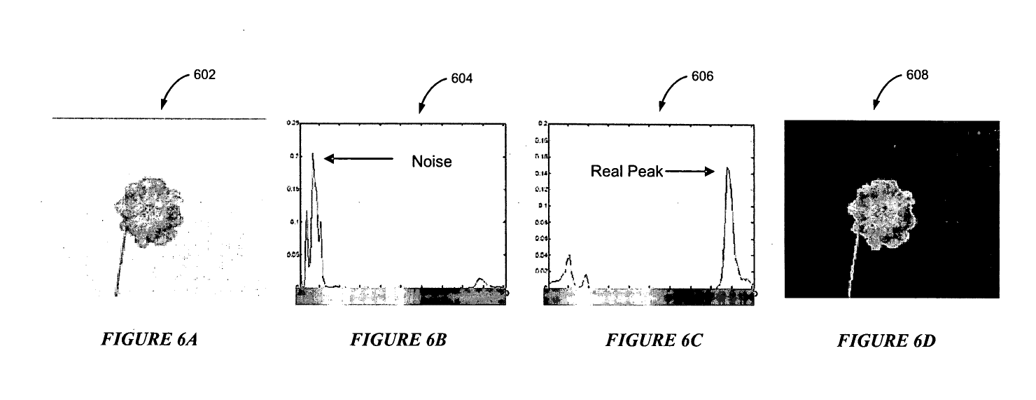

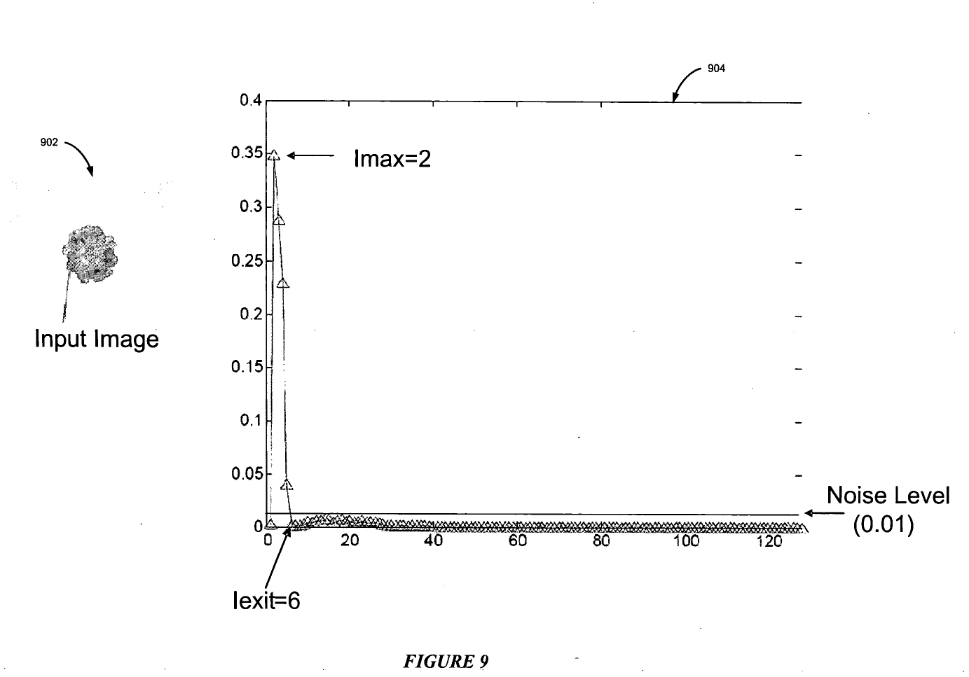

The controller 108 or other suitable component associated with the document processing device 104, the user device 114, or the like then extracts chroma data from the pixels comprising the received input image. A histogram is then generated from the extracted chroma data corresponding to the received input image. A suitable example of a histogram generated from extracted chroma data is illustrated in FIGS. 6B, 6C, and 9, as discussed in greater detail below. An adapted threshold value is then determined based upon extracted histogram data, as explained in greater detail below with respect to FIGS. 4A-10.

The threshold value is then compared to the component values of the pixels of the received input image so as to isolate near achromatic pixels. As will be understood by those skilled in the art, a near achromatic pixel refers to a pixel that has no color (achromatic) or is almost achromatic. A de-noising function is then applied to the image data in accordance with the near achromatic pixel isolation. In accordance with one example embodiment of the subject application, the hue concentration of the image is then capable of being detected based upon the de-noising function. Thereafter, pixels of the image are capable of being assigned to either the foreground of the input image or the background of the input image, in accordance with the near achromatic isolation of the pixels. It will be apparent to those skilled in the art that the detection of the hue concentration of the image and the pixel assignment described above are example applications of the methodology of the subject application only and are not intended to limit application of the subject methodology solely to such applications.

Turning now to FIGS. 4A-10, there are shown a myriad of examples illustrating the system and method for isolating near achromatic pixels of an input digital image in accordance with embodiments of the subject application. FIG. 4A depicts an input image 402 corresponding to a typical image received by the controller 108 or other suitable component associated with the document processing device 104, the user device 114, or the like. FIG. 4B, as shown, illustrates an image 404 corresponding to the image 402 of FIG. 4A. The image 404 of FIG. 4B is shown to illustrate the presence of near achromatic pixels, e.g., those pixels in image 404 as colored in blue. The skilled artisan will appreciate that the use of blue to illustrate near achromatic pixels is for purposes of clearly illustrating such pixels, and the association of the color blue to these pixels should not be interpreted to be indicative of the actual color component of the identified pixels.

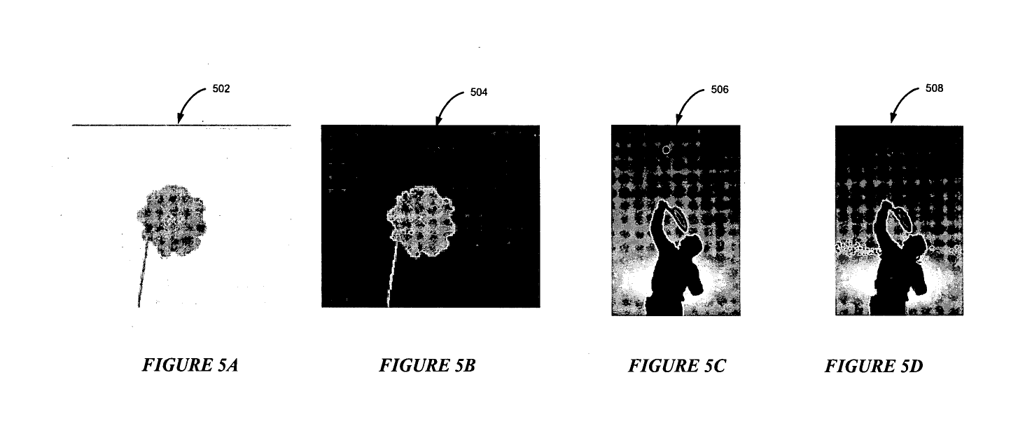

It will be appreciated by those skilled in the art that image processing typically requires the segmentation of the foreground and background of a received image. FIGS. 5A-5D illustrate the segmentation in accordance with one embodiment of the subject application. FIG. 5A illustrates an input image 502, while FIG. 5B depicts an image 504 corresponding to the image 502 with the background pixels colored blue. FIG. 5C illustrates an input image 506, with FIG. 5D showing an image 508 corresponding to the image 506 with the foreground pixels colored blue. The skilled artisan will appreciate that all pixels colored blue in FIGS. 5B and 5D represent those pixels in the input images 502 and 506 that are near achromatic.

The skilled artisan will further appreciate that image processing also typically requires de-noising for the detection of hue concentration. Thus, FIGS. 6A-6D illustrate the de-noising of an input image in accordance with one embodiment of the subject application. FIG. 6A depicts an input image 602 with FIG. 6B illustrating a hue histogram 604 in HSV (hue, saturation, value (brightness)) color space corresponding to the input image 602. It will be understood by those skilled in the art that the peaks shown in the histogram 604 of FIG. 6B illustrate noise associated therewith. FIG. 6C then illustrates a de-noised hue histogram 606 of the image 602 in HSV color space after near achromatic pixels have been discarded, resulting in the revealing of the true peaks of the histogram 606. FIG. 6D thus illustrates the discarded pixels, shown in blue, as a result of the de-noising performed in accordance with one embodiment of the subject application.

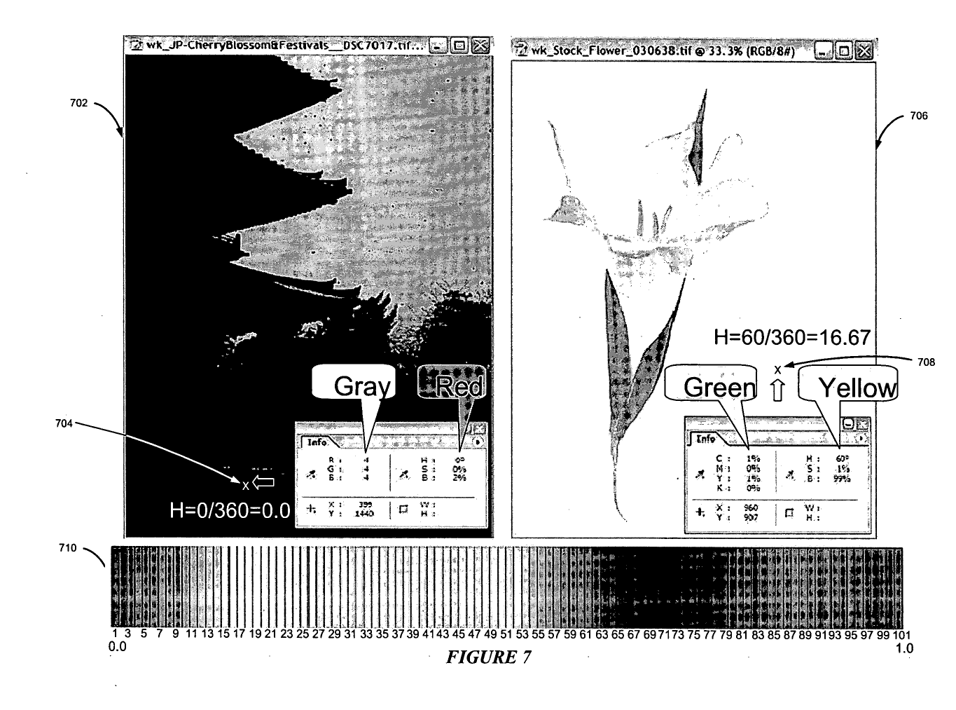

FIG. 7 shows two examples 702 and 706 in which pixels with low hue and saturation values are considered noise. The example 702 of FIG. 7 illustrates that the pixel 704, located at (399, 14440), has red, green, blue (RGB) values indicating that the pixel 704 is gray, i.e., neutral, achromatic, and yet its hue angle is zero, which is red as illustrated in the hue ramp 710. The example 706 illustrates that the pixel 708, located at (960, 907), has cyan, magenta, yellow, black (CMYK) values indicating that the pixel 708 is green, and yet its hue angle is 60 degrees, which corresponds to yellow as illustrated in the hue ramp 710. It will be appreciated by those skilled in the art that all hue values at these near achromatic pixels, e.g., pixels 704 and 708, are considered noise.

In accordance with one example embodiment of the subject application, the classification of near achromatic pixels from a received input image begins with a determination as to whether the computational cost associated with processing the image is above a predetermined level. When such a determination is positive, e.g., the image is very large, the input image is blurred, as will be understood by those skilled in the art, and down-sampled so as to reduce the computational cost associated with such processing. The skilled artisan will appreciate that such blurring and down-sampling of a received image is not necessary when the image size is limited, e.g., below the predetermined size.

The received image is then converted to a luminance-chrominance color space, e.g., CIE L*a*b*. The skilled artisan will appreciate that the blurred/down-sampled image is also, if necessary, converted to a suitable multi-dimensional color space, e.g., a luminance-chrominance color space. The chromatic information of the converted image data is then separated from the luminance (or brightness) information, whereupon a mathematical correlation of perceived “colorfulness” or chroma is readily calculated. In accordance with such an example embodiment, the skilled artisan will appreciate that the calculation of the chroma, in the L*a*b* color space, is accomplished via the equation of c*=(a*²+b*²)^{1/2}.

A histogram in chroma is then generated by the controller 108 or other suitable component associated with the document processing device 104, the user device 114, or other such computational device, as will be understood by those skilled in the art. The generated chroma histogram is then normalized by the number of pixels, hereafter designated as H. The maximum histogram count in H is then located and designated as Hₘₐₓ, such that H(Iₘₐₓ)=Hₘₐₓ, wherein the parameter I corresponds to both the histogram in number as well as chroma value, since the skilled artisan will appreciate that the step size of the constructed histogram is one (1) unit of chroma. An adapted threshold value, designated as Th, is then determined by the controller 108 or other suitable component associated with the document processing device 104, user device 114, or the like. A determination is then made as to whether the Iₘₐₓ value is greater than or equal to 9, e.g., whether or not Iₘₐₓ≧9. In the event that Iₘₐₓ is greater than or equal to 9, the adapted threshold value is set to 5. In the event that Iₘₐₓ is not greater than or equal to 9, I steps from values of 5 through 8 until H(Iₑₓᵢₜ) is less than 0.01, as will be understood by those skilled in the art. When H(Iₑₓᵢₜ) achieves less than 0.01, the adapted threshold value (Th) is set to Iₑₓᵢₜ−1, e.g., Th=Iₑₓᵢₜ−1. The determined threshold value is then applied to each pixel of the received image to determine whether or not the pixel is near achromatic, in accordance with the subject application.

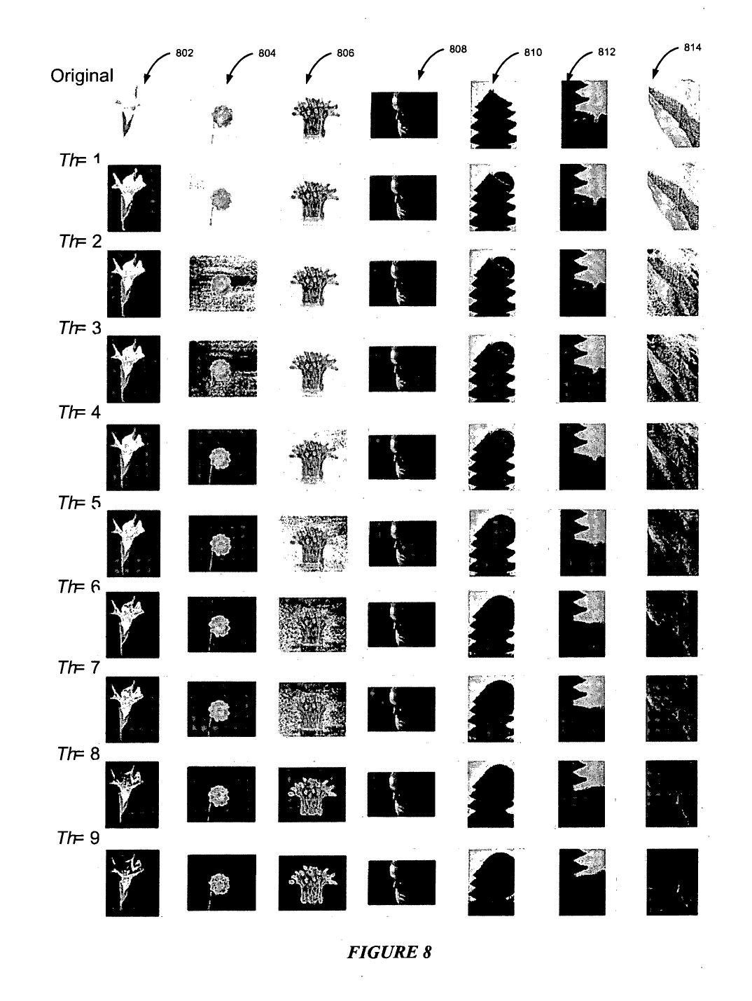

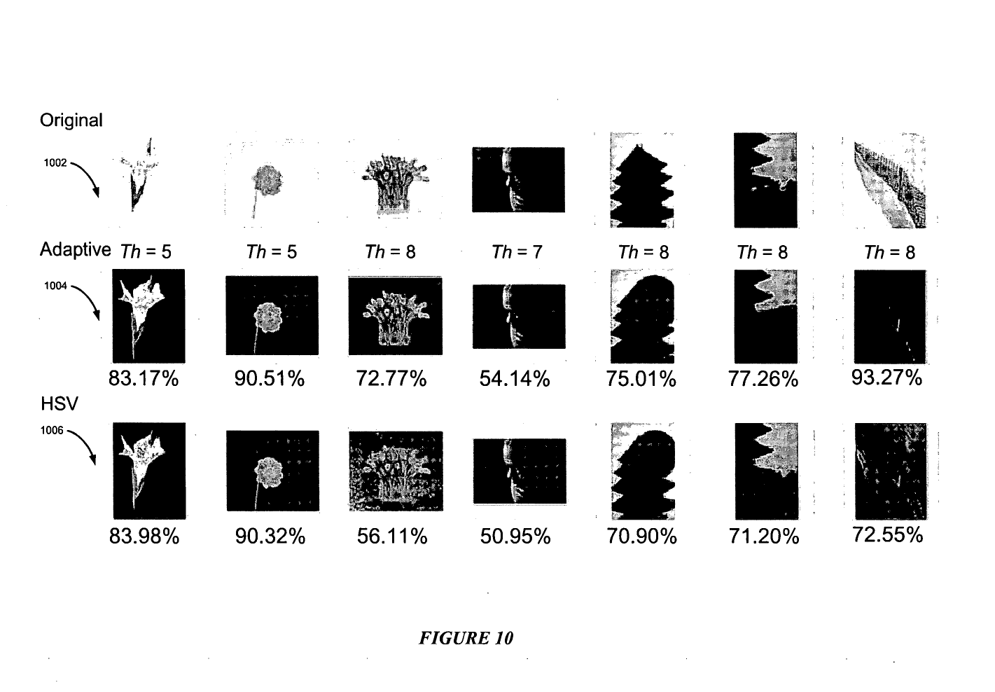

Turning now to FIG. 8, there is shown a set of sample images 802, 804, 806, 808, 810, 812, and 814 with progressive threshold in chroma from 1 through 9, thereby illustrating that no one single threshold value fits all input images. The determination of the adapted threshold value with respect to a received image is further illustrated via the analysis of the image's normalized histogram in chroma. Thus, FIG. 9 shows an example input image 902 and associated normalized histogram in chroma 904. The maximum histogram count (Hₘₐₓ) occurs at Iₘₐₓ=2, with stepping below 0.01 occurring at Iₑₓᵢₜ=6. Thus, through the application of the formula above, i.e. Th=Iₑₓᵢₜ−1, the adapted threshold is 5. FIG. 10 illustrates an original input image 1002, a resultant image according to the subject application 1004, and a resultant image from an HSV method 1006, such HSV method 1006 as is illustrated in U.S. Pat. No. 6,580,824 to Deng et al., which demonstrates the effectiveness of the subject application, as will be understood by those skilled in the art. The skilled artisan will further appreciate that the system and method for isolating near achromatic pixels of a digital image, as set forth in the preceding example embodiment, are also capable of being used with other luminance-chrominance spaces, such as xyY, u′v′Y, L*u*v*, YIQ, YC_{b}Cᵣ, and the like.

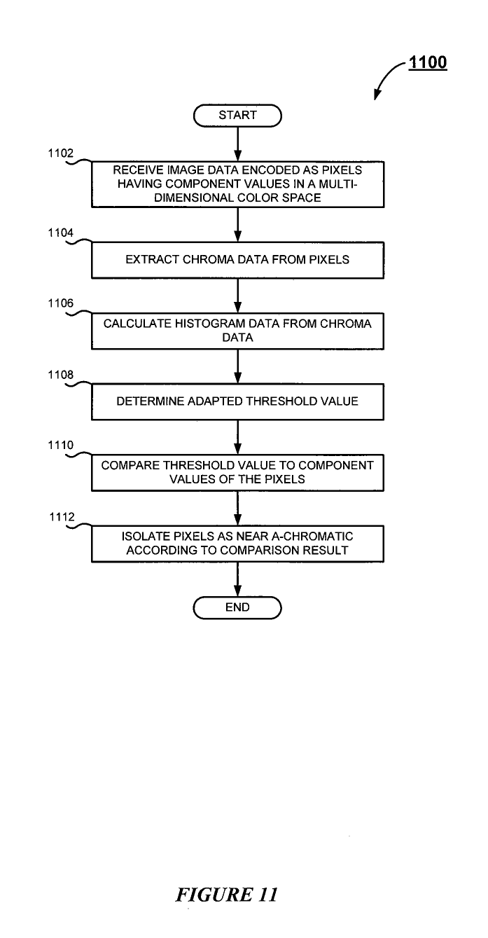

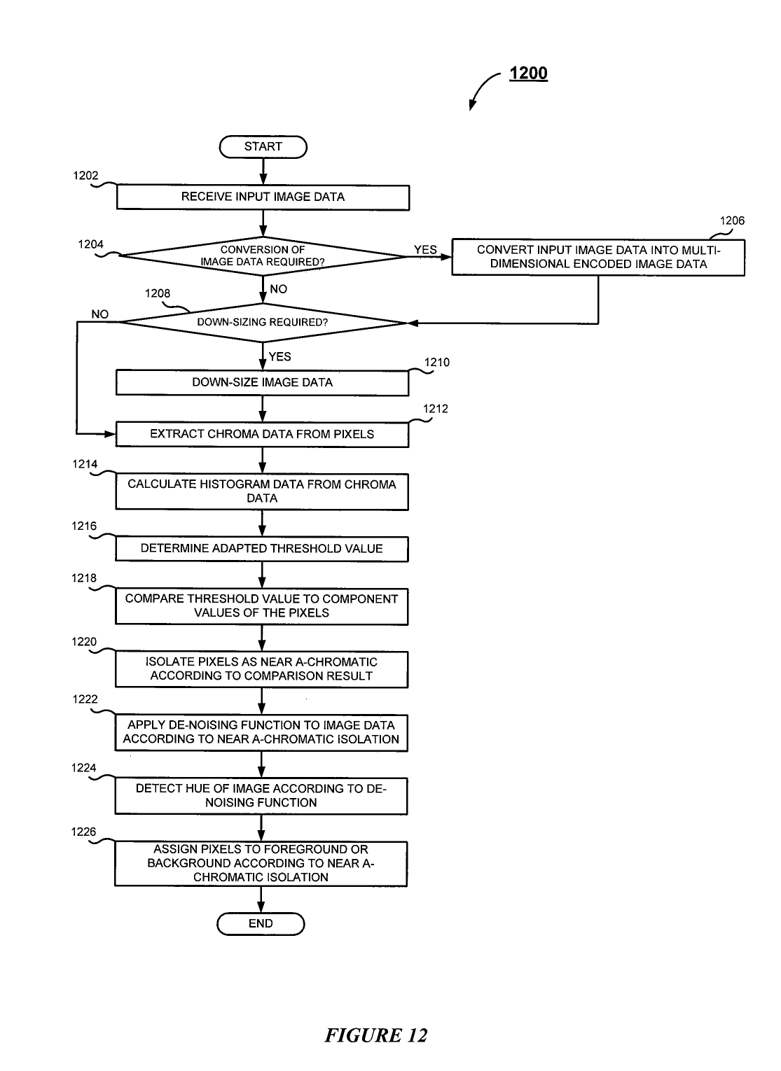

The skilled artisan will appreciate that the subject system 100 and components described above with respect to FIGS. 1-10 will be better understood in conjunction with the methodologies described hereinafter with respect to FIG. 11 and FIG. 12. Turning now to FIG. 11, there is shown a flowchart 1100 illustrating a method for isolating near achromatic pixels of a digital image in accordance with one embodiment of the subject application. Beginning at step 1102, image data, encoded as a plurality of pixels, is received by the controller 108 or other suitable component associated with the document processing device 104, the user device 114, or other suitable device capable of performing image processing in accordance with the subject application. Preferably, each of the pixels of the image data has component values in a multi-dimensional color space, e.g., RGB, CMYK, L*a*b*, xyY, u′v′Y, L*u*v*, YIQ, YC_{b}Cᵣ, and the like.

At step 1104, chroma data is extracted from the pixels of the received image data via any suitable means known in the art. The controller 108, other suitable component associated with the document processing device 104, the user device 114, or the like then calculates, at step 1106, histogram data from the extracted chroma data. An adapted threshold value is then determined at step 1108 based upon the calculated histogram data. A comparison is then made at step 1110 of the determined adapted threshold value to the component values of the plurality of pixels of the received image data. At step 1112, pixels are isolated as near achromatic in accordance with the output of the comparison between the determined adapted threshold value and the component values of the pixels of the received image data.

Referring now to FIG. 12, there is shown a flowchart 1200 illustrating a method for isolating near achromatic pixels of a digital image in accordance with one embodiment of the subject application. The methodology of FIG. 12 begins at step 1202, whereupon input image data, corresponding to an electronic image having a plurality of pixels associated therewith, is received by the controller 108 or other suitable component associated with the document processing device 104, the user device 114, or the like. The skilled artisan will appreciate that the controller 108, the document processing device 104, and the user device 114 are representative of any suitable computing devices capable of performing image processing in accordance with the subject application. It will be understood by those skilled in the art that the input image data represents any electronic image, in any of myriad various formats, e.g., JPEG, TIFF, PDF, RAW, BMP, etc. It will be further understood by those skilled in the art that the image data is encoded as a plurality of pixels, each having component values in a multi-dimensional color space, e.g., RGB, CMYK, HSV, CIE L*a*b*, YC_{b}Cᵣ, YIQ, xyY, u′v′Y, L*u*v*, or the like, as will be known in the art.

A determination is then made at step 1204 whether the received image data requires conversion into an acceptable multi-dimensional color space, e.g., conversion to luminance-chrominance color space encoded image data, conversion to HSV (Hue, Saturation, Value (brightness)) encoded image data, or the like. When it is determined at step 1204 that conversion is not required, flow proceeds directly to step 1208. When it is determined at step 1204 that conversion is required, flow proceeds to step 1206, whereupon the input image data is converted into an appropriate multi-dimensional color space, e.g., L*a*b*, HSV, or the like. A determination is then made at step 1208 as to whether down-sizing is required of the received input image data encoded in an acceptable color space. That is, a determination is made at step 1208 as to whether the received image exceeds a predetermined size, such that processing of the image at its current size will use a substantially large portion of the processing capabilities of the associated controller 108, other suitable component associated with the document processing device 104, the user device 104, or the like. Stated another way, the controller 108 analyzes the received image data so as to determine whether the large size of the image will result in a strain on computational resources.

When it is determined at step 1208 that the large size of the received input image will adversely affect the performance of the controller 108, the document processing device 104, the user device 114, or other similar device, flow proceeds to step 1210, whereupon the image data is down-sized, e.g., via blurring and/or down-sampling, as will be appreciated by those skilled in the art. Once the image data is compacted, flow proceeds to step 1212. When the controller 108 determines at step 1208 that no down-sizing is required, operations of the flow chart 1200 of FIG. 12 bypass step 1210 and proceed directly to step 1212.

At step 1212, chroma data is extracted from the plurality of pixels of the received image data by the controller 108 or other suitable component associated with the document processing device 104, the user device 114, or the like. That is, the chromatic information of the image data is separated from the luminance information, whereupon a mathematical correlation of perceived chroma is readily calculated. It will be understood by those skilled in the art that such a calculation, for example and without limitation, in the L*a*b* color space, is accomplished via the equation of c*=(a*²+b*²)^{1/2}. At step 1214, histogram data is calculated from the extracted chroma data. Suitable histograms corresponding to extracted chroma data are illustrated in FIGS. 6B, 6C, and 9, as discussed above. As also referenced above, the histogram calculated from the chroma data is preferably normalized by the number of pixels H and the maximum histogram count in H (Hₘₐₓ), such that H(Iₘₐₓ)=Hₘₐₓ. The skilled artisan will appreciate that I corresponds to both the histogram in number as well as chroma value for the reasons set forth above.

At step 1216, an adapted threshold value is determined in accordance with the calculated histogram data. That is, at step 1216, a determination is made as to whether the Iₘₐₓ value is greater than or equal to 9, for example, whether or not Iₘₐₓ≧9. When Iₘₐₓ is greater than or equal to 9, the adapted threshold value (Th) is set to 5. When Iₘₐₓ is not greater than or equal to 9, I steps from values of 5 through 8 until H(Iₑₓᵢₜ) is less than 0.01, as will be understood by those skilled in the art. Upon achieving a value of H(Iₑₓᵢₜ) less than 0.01, the adapted threshold value Th is set to Iₑₓᵢₜ−1, e.g., Th=Iₑₓᵢₜ−1, as illustrated in FIGS. 4A-10. In particular, FIG. 9, as explained above, provides a suitable example of a determination of an adapted threshold value Th in accordance with one embodiment of the subject application.

The threshold value Th is then compared to the component values of the pixels of the received input image at step 1218. At step 1220, pixels in the received image data are then isolated as near achromatic based upon the results of the comparison of the component values of the pixels to the threshold value Th. At step 1222, a suitable de-noising function, as will be appreciated by those skilled in the art, is applied to the image data in accordance with the near achromatic pixel isolation. In accordance with one example embodiment of the subject application, the hue concentration of the image is then capable of being detected based upon the de-noising function at step 1224. At step 1226, pixels of the image are then capable of being assigned to either the foreground of the input image or the background of the input image, in accordance with the near achromatic isolation of the pixels. It will be understood by those skilled in the art that the subject application includes steps 1224 and 1226 in FIG. 12 for example purposes only, thereby describing example applications of the methodology of FIG. 12; the skilled artisan will thus appreciate that such optional steps are not intended to require such steps in the method set forth herein.

The subject application extends to computer programs in the form of source code, object code, code intermediate sources and partially compiled object code, or in any other form suitable for use in the implementation of the subject application. Computer programs are suitably standalone applications, software components, scripts, or plug-ins to other applications. Computer programs embedding the subject application are advantageously embodied on a carrier, being any entity or device capable of carrying the computer program: for example, a storage medium such as ROM or RAM; optical recording media such as CD-ROM or magnetic recording media such as floppy discs; or any transmissible carrier such as an electrical or optical signal conveyed by electrical or optical cable, radio, or other means. Computer programs are suitably downloaded across the Internet from a server. Computer programs are also capable of being embedded in an integrated circuit. Any and all such embodiments containing code that will cause a computer to perform substantially the subject application principles as described will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A system for isolating near achromatic pixels of a digital image comprising:
means adapted for receiving image data encoded as a plurality of pixels, each pixel having component values in a multi-dimensional color space;
means adapted for extracting chroma data from pixels of received image data;
means adapted for calculating histogram data from extracted chroma data;
means adapted for determining an adapted threshold value from extracted histogram data;
comparison means adapted for comparing a determined adapted threshold value to component values of the plurality of pixels; and
isolation means adapted for isolating pixels as near achromatic in accordance with an output of the comparison means.

2. The system of claim 1 further comprising means adapted for assigning pixels to at least one of foreground and background of an image encoded in the image data in accordance with an output of the isolation means.

3. The system of claim 1 further comprising means adapted for applying a de-noising function to the image data in accordance with an output of the isolation means.

4. The system of claim 3 further comprising hue detection means adapted for detecting a hue concentration of an image encoded in the image data in accordance with application of the de-noising function to the image data.

5. The system of claim 1 further comprising:
means adapted for receiving input image data; and
means adapted for converting received input image data into the image data encoded in HSV color space.

6. The system of claim 1 further comprising means adapted for down-sizing image data prior to extraction of chroma data therefrom.

7. A method for isolating near achromatic pixels of a digital image comprising the steps of:
receiving image data encoded as a plurality of pixels, each pixel having component values in a multi-dimensional color space;
extracting chroma data from pixels of received image data;
calculating histogram data from extracted chroma data;
determining an adapted threshold value from extracted histogram data;
comparing a determined adapted threshold value to component values of the plurality of pixels; and
isolating pixels as near achromatic in accordance with an output of the comparison of the determined adapted threshold to component values.

8. The method of claim 7 further comprising the step of assigning pixels to at least one of foreground and background of an image encoded in the image data in accordance with an output of the step of isolating pixels as near achromatic.

9. The method of claim 7 further comprising the step of applying a de-noising function to the image data in accordance with an output of the step of isolating pixels as near achromatic.

10. The method of claim 9 further comprising the step of detecting a hue concentration of an image encoded in the image data in accordance with application of the de-noising function to the image data.

11. The method of claim 7 further comprising the steps of:
receiving input image data; and
converting received input image data into the image data encoded in HSV color space.

12. The method of claim 7 further comprising the step of down-sizing image data prior to extraction of chroma data therefrom.

13. A computer-implemented method for isolating near achromatic pixels of a digital image comprising the steps of:
receiving image data encoded as a plurality of pixels, each pixel having component values in a multi-dimensional color space;
extracting chroma data from pixels of received image data;
calculating histogram data from extracted chroma data; determining an adapted threshold value from extracted histogram data;
comparing a determined adapted threshold value to component values of the plurality of pixels; and
isolating pixels as near achromatic in accordance with an output of the comparison of the determined adapted threshold to component values.

14. The computer-implemented method of claim 13 further comprising the step of assigning pixels to at least one of foreground and background of an image encoded in the image data in accordance with an output of the step of isolating pixels as near achromatic.

15. The computer-implemented method of claim 13 further comprising the step of applying a de-noising function to the image data in accordance with an output of the step of isolating pixels as near achromatic.

16. The computer-implemented method of claim 15 further comprising the step of detecting a hue concentration of an image encoded in the image data in accordance with application of the de-noising function to the image data.

17. The computer-implemented method of claim 13 further comprising the steps of:
receiving input image data; and
converting received input image data into the image data encoded in HSV color space.

18. The computer-implemented method of claim 13 further comprising the step of down-sizing image data prior to extraction of chroma data therefrom.
